(19) United States
(12) Patent Application Publication
(10) Pub. No.: US 2010/0010909 A1
(43) Pub. Date: Jan. 14, 2010

(54) BENEFIT ORDERING AND COMPLIANCE SERVER

(76) Inventors: CHARLES T. MARSHALL, ATHERTON, CA (US); Devin Wade, Seattle, WA (US); Larry van der Veen, San Carlos, CA (US)

Correspondence Address: Richard Brewster Main, Esq., Patents Pending, 9832 Lois Stiltner Court, Elk Grove, CA, 95624, US

(21) Appl. No.: 12/172,201

(22) Filed: Jul. 11, 2008

(51) Int. Cl. G06Q 30/00; G06Q 10/00

(52) U.S. Cl. 705/26

(57) ABSTRACT

A benefits ordering system provides flexible spending account debit cards to employees and allows their employer to enroll in a Plan that ensures compliance with ERISA regulations. The system applies compliance rules during a data collection and plan definition stages of ordering, and produces an ERISA-compliant Plan and documentation as legally required. A directed questioning and answering wizard guides companies and participants through the placing of orders for products. The particular sequence of questions is dependent on the products being ordered, and the parameters drive variations in the plans. Rules and parameters are built into libraries used by the system, and it is these that direct the information collection flow. Each type of Plan is constructed from previously composed paragraphs that are threaded together to encapsulate the parameters and include the required components. Plans can be modified, if new compliance rules must be met, based on changing parameters.

### BACKGROUND

1. Field of the Invention

The present invention relates to automated ordering systems and methods, and more particularly to on-line webpages and wizards for stepping a plan administrator through the design and purchase of a benefits plan for their employees. These specifically involve the use of debit cards associated with Flexible Spending Account (FSA) plans, and the so-called Inventory Information Approval System (IIAS), a point-of-sale system that electronically identifies eligible healthcare FSA purchases.

2. Description of the Prior Art

The most widely circulated prepaid payment cards in the United States include branded open-loop gift cards and healthcare related prepaid cards. These have become more than just a means of rendering payment, managing multi-purse transactions, and providing patient data.

Americans spend over $23 billion on over the counter (OTC) items each year. On average, the typical family buys about $250 each year. Prescriptions are for medications deemed safe only under the supervision of a doctor. All prescriptions qualify as an eligible expense, and Americans spend over $250 billion on prescriptions each year.

The most common conditions treated are Flu, Sinus Infection, Strep Throat, Bronchitis, Headaches, Earaches, Ear Infections, Minor Skin Rashes, Minor Burns, Poison Ivy, Urinary Tract Infections and Wart Removal. In addition, most clinics also offer shots/vaccinations and pregnancy tests.

If an employer in private industry in the United States establishes a retirement and health benefit plan for their employees, then the Employee Retirement Income Security Act of 1974 (ERISA) sets the minimum standards. Otherwise, at a minimum, the Plan will not qualify the employees nor the employer for special tax treatments. ERISA covers retirement, health, life, disability, apprenticeship, and other types of plans.

The individuals who manage such plans are also required by ERISA to meet certain standards of conduct. There are detailed provisions for reporting information to the Government and making certain disclosures to their employee participants. These provisions are aimed at assuring the plan funds are protected, and that the participants who qualify actually do receive their benefits.

ERISA was expanded by the Consolidated Omnibus Budget Reconciliation Act of 1985 (COBRA) to provide for the continuation of health care coverage for employees and their beneficiaries even after leaving employment. The Health Insurance Portability and Accountability Act of 1996 (HIPAA) amended ERISA to make health care coverage more portable and secure for employees.

One visit to the US Department of Labors website at www.dol.gov/ebsa/compliance_assistance.html, will be enough to convince any small employer that the selection, startup, management, and maintenance of any ERISA plan will be complex, burdensome, and probably beyond their non-expert abilities or comfort. Large corporations, of course, will have the expert staffs needed to deal with the complexities of ERISA plan selection and reporting.

In 2006, the IRS issued Notice 2006-69 which provided guidance on the use of debit cards associated with FSA plans. Central to this is the IIAS. The IIAS system works by comparing inventory control information of items being purchased against a pre-established list of eligible medical expenses. The merchant's system identifies the eligible expenses and allows payment.

Pharmacies each have until 2009 to establish an IIAS system, while purchases for services rendered at physician's offices, dental and vision clinics are not subject to the requirements.

A group of companies involved in supporting FSA and Health Reimbursement Arrangement (HRA) debit card transactions formed a working group called the IIAS Standards Interest Group to establish a voluntary industry standard to meet IRS requirements for operating an IIAS by the mandated deadline of Jan. 1, 2008. The working group incorporated as the Special Interest Group for IIAS Standards (SIGIS) to manage the standards on an on-going basis. SIGIS includes a broad range of retailers, card issuers, third party plan administrators (TPA's), merchant acquirers, processors, financial institutions, trade association groups, software vendors, payment card networks, and other participants.

MasterCard and Visa have published technical requirements in support of the standard published by the Special Interest Group for IIAS Standards. As a result, in October 2007, FSA/HRA card issuers and processors were able to support the processing of real-time or automatic substantiation of the amount of eligible medical expenses in a cardholder's purchase.

IIAS-compliant transactions enable real-time, auto-substantiation that funds approved for disbursement from an FSA/HRA card are for eligible medical items. IIAS transactions represent a more cost-effective approach than previously was possible for pharmacy and over-the-counter medical purchase offerings. Consumers with FSA and HRA cards are able to use their cards more conveniently than before, reducing the number of sales receipts they would have to submit after using their FSA/HRA card.

If a retailer's merchant category code (MCC) is not healthcare related, the IRS does allow plan administrators to approve FSA/HRA card transactions until these merchants support an IIAS. Retailers with non-healthcare MCC's were able to continue accepting their customers' FSA or HRA cards after Jan. 1, 2008, by implementing the SIGIS standard. Retailers that identify eligible healthcare items on all sales receipts, regardless of the method of tender, will be more FSA-friendly for all customers.

What is needed is an on-line tool to allow small and medium sized companies to select, purchase, and fund a proper ERISA plan that will truly benefit the employees and employer while complying with ever changing and subtle federal laws in the area.

### SUMMARY OF THE INVENTION

Briefly, a benefits ordering system embodiment of the present invention ensures compliance with ERISA regulations as they pertain to various programs and products. The system applies compliance rules during the data collection and plan definition stages of ordering, and produces an ERISA-compliant Plan and documentation as required. A directed questioning and answering wizard guides companies and participants placing orders for products. The answers to a series of questions elicits the information and parameters needed to build an ERISA-conforming Plan. The particular sequence of questions is dependent on the products being ordered and parameter driven variations of the plans. Each product line has a unique set of rules and parameters to describe compliance. Rules and parameters are build into libraries used by the system. These libraries direct the information collection flow. As information is collected during the ordering process, the parameters are saved in the relational database. The essentials of the Plan are stored, and the whole can be reconstructed on demand. Plans are constructed based upon the parameters collected during the ordering and data collection process. Each type of Plan is constructed from previously composed paragraphs that are threaded together to encapsulate the parameters and include the required components. If new compliance rules are issued, each Plan can be modified simply by changing the stored parameters which define the Plans.

An advantage of the present invention is that the ordering and design of a proper ERISA plan is automated, and a fully compliant plan can be quickly and easily assembled by non-experts.

These and other objects and advantages of the present invention will no doubt become obvious to those of ordinary skill in the art after having read the following detailed description of the preferred embodiments which are illustrated in the various drawing Figs.

### IN THE DRAWINGS

FIG. 1 is a functional block diagram of an FSA benefits ordering system embodiment of the present invention;

FIG. 2 is a functional processes diagram of an employee benefits applications service provider (ASP) embodiment of the present invention;

FIG. 3 is a block diagram of a blade design that could be used to implement the ASP of FIG. 2 or the FSA benefits ordering system of FIG. 1;

FIG. 4 is a block diagram of an FSA payment card benefits system embodiment of the present invention;

FIG. 5 is a block diagram of a benefits ordering platform embodiment of the present invention; and

FIG. 6 is a block diagram of a triage process flow and ordering method for a prepaid healthcare card product.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the several Claims.

### DETAILED DESCRIPTION OF THE PREFERRED EMBODIMENT

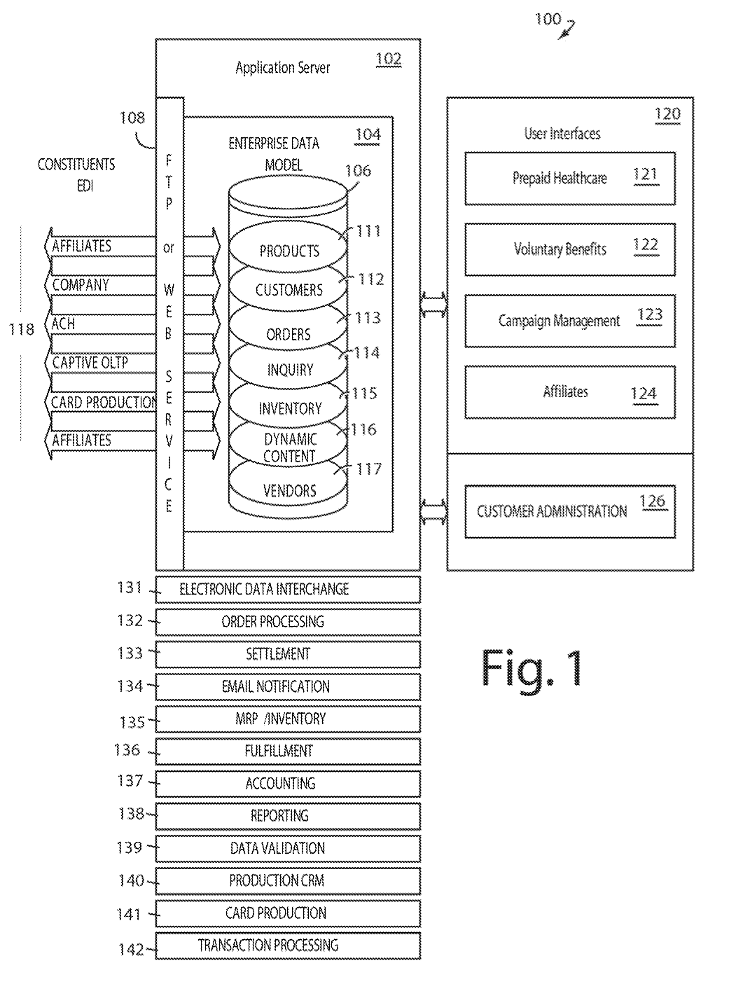

FIG. 1 represents an employer benefits ordering system embodiment of the present invention, and is referred to herein by the general reference numeral 100. Each employer benefits ordering system 100 is typically implemented as an Internet webserver to allow thousands of users to access it and do business with it quickly and efficiently online. The unique aspects include the automated assembly and operation of a benefits plan based on answers provided during an initial question and answer session controlled with a wizard.

An employer benefits ordering system application server 102 includes an enterprise data model 104 with a main database 106. These are accessed by file transfer protocol (FTP) or web service (Internet) through a communications interface 108.

Most data, with the exception of card transaction and balance information, is stored in the application server 102. Such data is logically tabled into seven categories, e.g., products 111, customers 112, orders 113, inquiries 114, inventory 115, dynamic content 116, and vendors 117. The products table 111 describes and prices every product offered through an Ordering Platform. For example, internal products, like a Prepaid Healthcare MasterCard, or an external Voluntary Benefit like a small business dental plan. The customer table 112 includes information about the companies who have ordered benefits systems for their employees.

The orders table 113 includes transaction line items that make up an order, where an order is defined as a set of products for a certain price. An order is governed by an ERISA-compliant benefit plan. The inquiry table 113 includes information retrieved from a transaction processor and consists of cardholder account history and account balance information. This table is not populated unless the cardholder requests information.

Inventory 115 is maintained for current card stock on hand within the inventory table, and is the basis for materials requirements planning (MRP) and financial reconciliation. A data table for dynamic content 116 is allocated for capturing custom information used for branded presentations. The vendor table 117 stores information related to a vendor and their respective products and services.

Constituent electronic data interchange (EDI) 118 typically provides interfaces to pre-paid healthcare (PPHC) companies, cardholders, PPHC affiliates, and administrators, and also automated clearing house (ACH), captive on-line transaction processing (OLTP), card production, etc. User interfaces 120 provide assess for PPHC 121, voluntary benefits 122, campaign management 123, and affiliates 124. A customer administration 126 is included to control how customers are handled.

An essential function of a benefit ordering system 100 uses a wizard on a webpage to lead a new customer through a series of dialog steps. The wizard will engineer the eventual plan to fit with the corresponding ERISA regulations for targeted programs and products. The system applies compliance rules during a data collection and plan definition phase of plan ordering, and the webserver ultimately assembles an ERISA-compliant Plan contract with the appropriate legal documentation.

A structured question and answer wizard is presented on a webpage to companies and participants placing orders for products. It has similarities with a medical triage process, in that questions are asked to decide what part to do first, and what consequences are triggered by the direction each response provides. The answers to a sequence of critical questions asked by the wizard provide the information and parameters needed to build an ERISA-conforming benefits Plan. The particular sequence of the questions depends on the products being ordered, each branch in the line of questioning can be unique. The new customer can then be relieved of answering questions that are not relevant to their intended purchase. Particular plan variations will depend on the parameters elicited in real-time from the company client by the wizard.

Each product line has a unique set of rules and parameters to describe compliance. Rules and parameters are build into libraries used by system 100. These libraries direct the information collection flow. As information is collected during the ordering process, the essential parameters are saved in a relational database. This distilled type data store completely represents the Plan, and can be reconstituted on demand with fillers and boilerplate needed to print out a legal contract document.

Plan construction is based on the parameters collected during an ordering and data collection process. The main document for each type of Plan is assembled from previously composed paragraphs and are threaded together to accommodate the parameters and include the required components. Plans can be modified, if new compliance rules are met, based upon changes in the essential parameters used to characterize each Plan.

System 100 is data-centric, an enterprise database 106 forms a nucleus of the system, and is surrounded by a server back end. The application server and processing engine controls how the major elements function and interact with the database and all types of users.

Each application server 102 supports a web-based user interface that provide views into the database for customers and an e-commerce ordering platform for end-users. Each EDI 118 interface provides data communication between a central operator, like Wired Benefits, Inc., and manufacturers, distributors, client companies, ACH banking, card transaction processors, and other partners.

An electronic data interchange module 131 provides for periodic exchange of data with customers, affiliates and processors for the purpose of ordering, reporting, and maintaining cardholder and customer information, interacting with the OLTP system, and maintaining information from affiliates. Encrypted flat files and web services are typically used to support the transfer and authentication of information. Data is batch processed for flat files, and processed in real-time if requests are made through a Web Services request.

An order processing module 132 is a typical e-commerce system, orders are placed into a “shopping cart” and processed at the conclusion of a buying session. These orders can represent a single session, or they may be marked for automatic periodic recurrence. Each order is subject to an ERISA-compliant benefit plan. A plan is automatically created, based upon a triage process that runs during each order.

A settlement module 133 provides for collecting the funds for products purchased from various sources, depending upon a set of business rules for a given customer. Settlement is derived from customers for the full amount of an order. Settlement is accomplished via an Automated Clearing House (ACH) process, or other electronic check system, based upon banking information and permissions provided by the customer.

An Email/Cell Phone Notification module 134 enables customers and cardholders to receive text notifications by email via a generalized email processor and by short message service (SMS) via an SMS gateway. Notifications are sent for each order, and incentives based on specific promotions are triggered by an on-line transaction processing (OLTP) processor.

Other conventional modules include materials requirement planning (MRP) and inventory 135, order fulfillment 136, financial accounting 137, financial reporting 138, data validation 139, production customer relation management (CRM) 140, card production 141, and transaction processing 142.

An example of the graphical user interface (GUI) for a benefit ordering platform is on the Internet at www.prepaidhealthcare.com, by Wired Benefits, Inc. The present invention can be implemented as a prepaid healthcare (PPHC) MasterCard™ in an ERISA-compliant benefit program for small employers. Such a platform offers access to voluntary benefits offered by affiliates, and has available to it the information needed to sell benefit programs to small employers. It creates an ERISA qualified plan for the employer during an interactive ordering process, and tracks purchases and assists with automatic reordering.

The PPHC uses third party and internal OLTP systems. For the Prepaid Healthcare MasterCard, system 100 can utilize the Metavante HCSz processor to capture and clear IIAS compliant transactions, or it can use an on-line transaction processor.

A comprehensive administrative website provides financial and activity reports to partners, statements and card balance related to cardholders, and the ability to manage card production and reloads.

Eligible employees receive personalized FSA cards to use for paying healthcare expenses. Small employers can decide what amount will be loaded onto each card. Employers may then reload cards with any value at any time. The cards are restricted to health care services such as medical, dental, or vision care, or everyday over-the-counter products. Such cards do not provide access to cash. There are no hidden fees, and reimbursements of qualified expenses are tax-deductible for the employer. Each HRA meets all IRS, ERISA, HIPAA and COBRA regulations and guidelines. HRA cards are accepted at all healthcare providers who accept the MasterCard® debit card. The FSA card is accepted at all IIAS certified merchants and pharmacies where prescriptions and over-the-counter medications are sold. These merchants and pharmacies are beginning to host retail health clinics which require no appointment and post a price list for roughly 30 common illnesses, skin conditions, lab tests and shots.

All major merchants are IIAS certified, for example, Wal-Mart, Sam's Club, Target, Longs, Safeway, Ralphs, Albertsons, Kroger, CVS, Lucky, Shaws, Jewel and OSCO.

A wizard would typically provide a first screen to a new customer that asks several questions, e.g., as in. Table-I,

TABLE I

```
Employer Info
    How many W-2 employees does the company have, excluding
contractors and IRS-1099 employees?
    How many W-2 employees of these can be considered to be
an owner, owner's spouse, or dependent?
    Should any of the following groups be excluded in addition to
owners, their spouses and their dependents?
        Part-Time Employees;
        Younger than 25 years old;
        Employed with the company for less than 3 years;
        Non-Resident Alien.
    How much to funding to load for each employee?
        (Enter any dollar amount between $10-$5,500)
Enter the names of each eligible employee
```

Typical Order Summary of Charges

| Item | Qty | Amount | Total |
|---|---|---|---|
| Setup Fee (one-time) | 1 | $79.95 | $79.95 |
| Card Load | 10 | $25.00 | $250.00 |
| Issuance Fee | 10 | $4.95 | $49.50 |
| | | Total: | $— |

System 100 can be operated as a so-called Application Service, presenting a web interface that allows external access the interactive platform functionality. In one experimental use that worked well, Microsoft Windows Server 2008, IIS, Application Services, and .NET were used for the web environment. The database was implemented with MySQL on Solaris. The ASP platform was hosted in two redundant locations by Wired Benefits. Access to the ordering platform was secure and restricted to PPHC customers and cardholders. Controlled access to the administrative site was provided to business partners, to create campaigns and access administrative reports and capabilities.

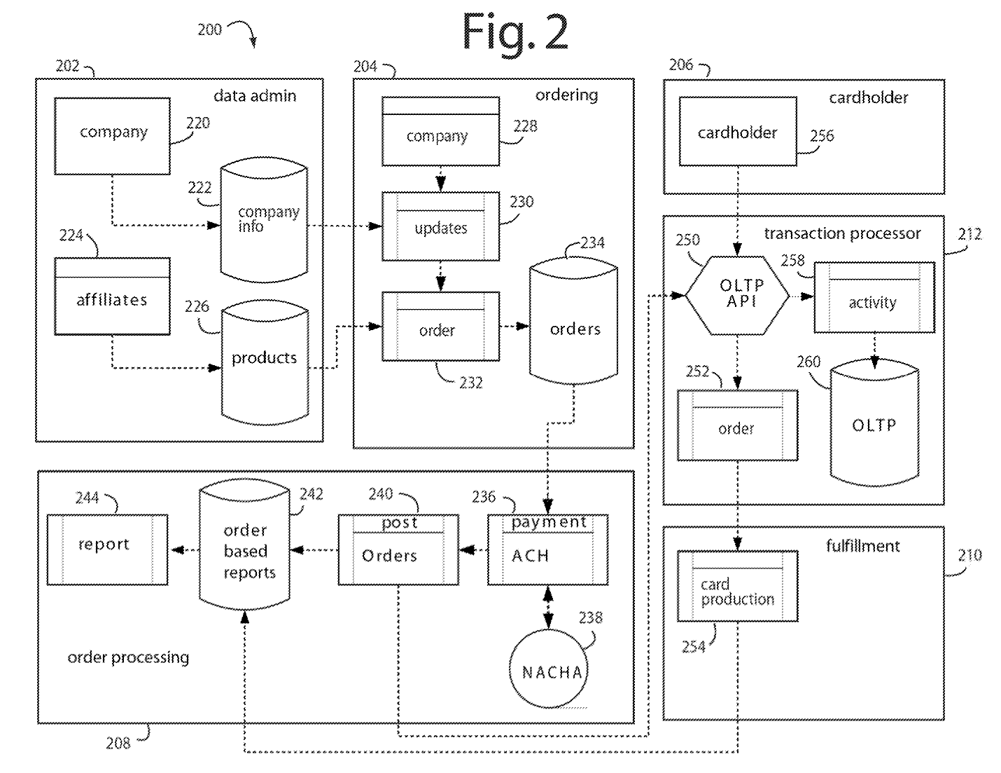

FIG. 2 illustrates an employee benefits applications service provider (ASP) 200 with a data repository process 202, company ordering process 204, cardholder access process 206, OLTP process 208, fulfillment process 210, and back-end order transaction process 212. Generally, these processes are separated and use data tables or formal application program interfaces (API's) to communicate orders that have been placed, the status and state of subsequent order processing, and other shared information. Only the ordering 204 and OLTP inquiry 208 need to be real-time functions and exposed to the user. All the others can be reserved to a business operator, like WiredBenefits, and their affiliates.

The data repository process 202 is used to manage employer, cardholder beneficiary, and product information. The employer and beneficiary information describe the products and services offered. Product data is the basis from which benefits are presented to companies.

During ordering, each company uses a web user interface to establish the basic benefit plan, and then to view and order products. A company process 220 includes registration, authentication, set-up plan, and employee roster. Company data is stored in a companies database 222. An affiliates process 224 obtains product, price, fees, and rules information which is stored in a products database 226. The particular products and services made available to companies can be restricted according to predefined business rules. For example, a rule might be established to enable only the Prepaid Healthcare MasterCard and voluntary dental insurance to be offered only to companies that are headquartered in Alabama.

Once authenticated by an on-line process 220 that handles log-in, views, ordering, and payment, each user is presented with a set of web pages to facilitate the creation of an ERISA-compliant plan and the subsequent ordering of products. An update process 230 accepts updates for ACH account data, email addresses, mailing addresses, etc. In an order process 232, each company user chooses the products and level of funding they want for each. Functions on screen include selecting, confirming, saving, and recurring. The completed orders are stored in a database 234. An ERISA-compliant plan is automatically generated for the current order, and any subsequent orders which can be simplified.

Email and SMS text messaging are relied on to communicate with customers and affiliates. Reports are generated and distributed to provide notices regarding orders and order status changes. Cardholders are also contacted by email and SMS to advertize incentives and promotions.

The employee benefits ASP 200 may appear to use a conventional “shopping cart” model for accumulating and processing orders, but it differs dramatically from prior art shopping carts in terms of user design process flow. The primary differences with the employee benefits applications service are that no real-time processing is performed, settlement occurs on a nightly basis via an ACH payment process 236 with the National ACH Association (NACHA) 238. A posting process 240 enters the paid-for orders for an order based report database 242. An orders report 244, either electronic or hardcopy, is finished.

Orders automatically recur if opted, and an ERISA qualified benefit plan is produced from the ordering process. Recurring orders for products are set up once and then recur without intervention from the company, if desired. There are circumstances where transactions are disapproved or ACH fails. Under these circumstances, recurring and pending orders are cancelled until the problem is resolved.

An on-line transaction processing (OLTP) applications program interface (API) 250 receives the new orders and establishes the necessary files and orders cards with a order media process 252. A card production process 254 produces, packages, and ships the new cards to the cardholders. Then a cardholder process 256 allows authentication, statement viewing, viewing balances, and loss/stolen reporting.

When the card is used at a POS location, a data activity process 258 obtains balances, history, status changes, and can load the card with funds. A database 260 stores OLTP transactions.

During a processing cycle, an employee benefits applications service communicates orders and receives approval through the transmission of flat files or execution of web service transactions with the necessary data. For example, order files are provided to initiate the production and fulfillment of new cards with a card production process. National Automated Clearing House Association (NACHA) files are produced for collection of ACH payments. Card loads as well, use web service calls to the processing platform to adjust balances.

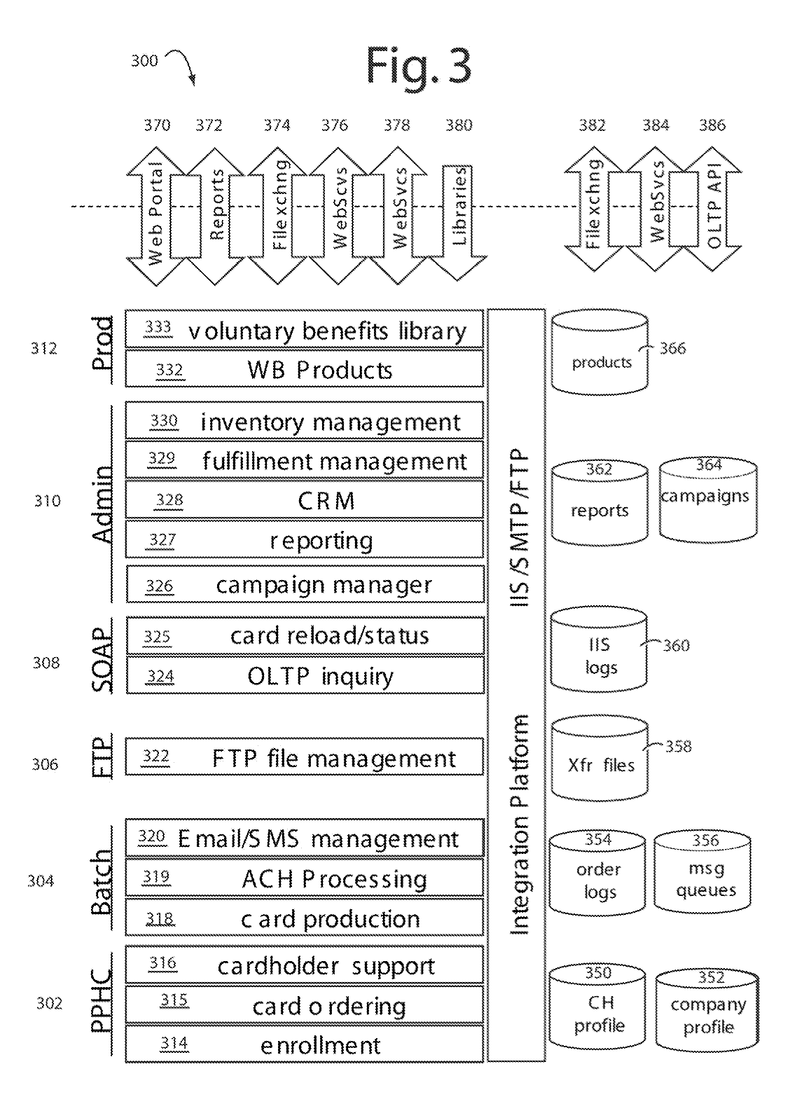

FIG. 3 represents how ASP 200 (FIG. 2) could use state-of-the-art blade architecture to implement a blade design 300. Blade designs have been popularized by IBM and Sun Microsystems, and have demonstrated how useful and beneficial it is to construct a modular system this way. ASP blade design 300 includes a PPHC subsystem 302, a batch processor 304, an FTP function 306, a simple object access protocol (SOAP) callable web server 308, an administrator 310, and a products manager 312. The PPHC subsystem 302 includes an enrollment blade 314, card ordering blade 315, and a cardholder support blade 316. The batch processor 304 includes a card production blade 318, an ACH processing blade 319, and an email/SMS text messaging blade 320. The FTP function 306 includes an FTP file management blade 322. The SOAP webserver 308 includes an OTLP inquiry blade 324, and a payment card reload and status blade 325. The administrator 310 includes a campaign manager blade 326, a reporting blade 327, a customer relation management (CRM) blade 328, a fulfillment management blade 329, and an inventory management blade 330. The products manager 312 includes a products blade 332, and a voluntary benefits library blade 333.

All these blades are backplaned to an integration platform 340 that hosts, e.g., access to Metavante financial services, Microsoft Internet Information Services (IIS), media transfer protocol (MTP), and file transfer protocol (FTP). The whole then has access to a customer profile database 350, a company profile database 352, an order log 354, message queues 356, transfer files 358, IIS logs 360, reports 362, campaign database 364, and products database 366.

The blades 314-333 communicate themselves through web portals 370, reports 372, file exchanges 374, web services 376, other services 378, and libraries 380. Direct communication with databases 350-366 can be through file exchanges 382, web services 384, and OLTP API's 386.

Blade design 300 provides a PPHC website when connected to the Internet for use by companies to order new benefits plans and for cardholders to access support. Data, grouped in batches, can be scheduled and processed by command of a smart scheduler. FTP services are provided as a portal for affiliates and certain transaction processors to push and pull files. Web services handle real-time transactions in support of cardholders and accounts. An administrative web site is provided for use by affiliates and the business operator, like Wired Benefits, to manage and view processing and transaction detail and customer issues. A specialized website is used to create and manage promotional campaigns. A products library carries full descriptions of all benefits offered.

The interfaces 370-386 are primarily accessed as web pages, but some processes are exposed as SOAP-callable web services. Each interface has a set of corresponding data tables or files that are used to communicate data and transactions to other parts of the application suite.

In general, a wizard is a user interface element where the user is presented with a sequence of dialog boxes. Through these dialog boxes, the user is led through a series of steps, performing tasks in a specific sequence. Sometimes it may otherwise be possible to reach the same result without using the wizard. However, it may be easier to perform this task using the wizard, especially for complex or infrequently performed tasks where the user is unfamiliar with the steps involved.

In contrast to a wizard, an expert system uses software to mimic human experts in a specific problem domain, and is a traditional application of artificial intelligence. A wide variety of methods can be used to simulate an expert, the most common ways use a so-called “knowledgebase” which uses some knowledge representation formalism to capture the subject matter expert (SME) knowledge, and processes for gathering knowledge from SME's and codifying if according to the formalism, e.g., knowledge engineering. Once a system is developed, it is proven by watching it in the same real world problem solving situation as the human SME.

Web applications, such as airline booking sites, also make use of wizards to complete lengthy interactive processes. Oracle Designer also uses wizards extensively. By contrast, expert systems guide the user through a series of questions to solve a problem, and tend to make use of artificial intelligence or other complex algorithms.

The Employee Retirement Income Security Act (ERISA) of 1974 was enacted to protect the interests of employee benefit plan participants and their beneficiaries by requiring the disclosure to them of financial and other information concerning the plan.

Health care services are defined as medical, dental, or vision care, services, or goods that qualify as tax deductible medical care expenses under Section 213 of the Internal Revenue Code, or medical care, services, or goods having substantially the same purpose or effect as such deductible expenses. The Inventory Information Approval System (IIAS) maintains a list of eligible items, comparing items in real-time at the check out counter to make a determination of which items are eligible and which are not.

When a card is swiped at an IIAS certified merchant, the point-of-sale device automatically identifies, separates and authorizes eligible items. Card purchases are only authorized for the eligible items. The cardholder will be prompted to pay for any other items with another form of payment. Cards will be denied at all non-certified merchant points-of-sale.

Health Reimbursement Accounts, (HRAs) are IRS-sanctioned arrangements that allow an employer to reimburse employee's medical expenses. Reimbursements of qualified expenses are tax-deductible for the employer and are tax free for the employee.

A personalized, embossed card is issued for health care. A fee can be assessed during the ordering process in addition to any dollar value loaded on to the FSA card.

If an employee reports a FSA card lost or stolen, and requests a replacement card, there can be a fee assessed to the card. This fee covers delivering and activating the new FSA card, with a charge balance is added to the new FSA card.

Some of the categories of over-the-counter (OTC) items include acne, allergy, antacids, asthma, baby care products, cold and flu medicines, diabetic supplies, first aid, nasal decongestants, pain relievers, and smoking cessation medicine.

Each time after initial load, small business owners add value to existing FSA cards. Small business owners may reload value annually, quarterly, monthly or as often as desired. This fee is assessed during the ordering process and is in addition to the value loaded on to each FSA card.

In one business model embodiment, a one-time set up fee of $79.95 charged to the employer. An Issuance Fee of $4.95 per card, and monthly fees of $2.95 per card are also charged to the employer. Both the card issuance fees and the monthly fees are deducted from the Employer Spending Requirement (ESR), so the ongoing fees come out of the amount the cardholder are required to spend. One other fee is a card replacement fee of $12.95, if a card is lost or stolen, which will also be deducted from the ESR amount.

The Employee Retirement Income Security Act (ERISA) requires plan administrators—the people who run plans—to give plan participants in writing the most important facts they need to know about their retirement and health benefit plans including plan rules, financial information, and documents on the operation and management of the plan. Some of these facts must be provided to participants regularly and automatically by the plan administrator. Others are available upon request, free-of-charge or for copying fees. The request should be made in writing.

One of the most important documents participants are entitled to receive automatically when becoming a participant of an ERISA-covered retirement or health benefit plan or a beneficiary receiving benefits under such a plan, is a summary of the plan, called the summary plan description (SPD). The plan administrator is legally obligated to provide to the SPD to participants free of charge.

The summary plan description is important because it tells participants what the plan provides and how the plan operates. The SPD provides information on when an employee can begin to participate in the plan, how service and benefits are calculated, when benefits becomes vested, when and in what form benefits are paid, and how to file a claim for benefits. If the plan is changed, its participants must be informed, either through a revised summary plan description or a summary of material modifications.

In addition to the summary plan description, the plan administrator must automatically give participants each year a copy of the plan's summary annual report. This is a summary of the annual financial report that most plans must file on Form 5500 with the Department of Labor. The summary annual report is available at no cost to participants.

Health Reimbursement Arrangements (HRA) Plans resulted from a Jun. 26, 2002 Treasury Department Revenue Ruling. This series of Revenue Ruling, allowed employers to use HRA plans to fund accounts on behalf of plan participants for eligible items under Internal Revenue Code sections 105, 106 and 213 (d).

Health Savings Accounts (HSA) were first enacted as a part of the Medicare Prescription Drug Improvement and Modernization Act of 2003. Participants needed access to tax advantaged savings accounts to help pay for medical expenses not paid for by insurance. The new higher deductible health plans would reduce overall costs to employers, and make affordable insurance available to more employees. Participants are responsible for paying a portion of their medical expenses out of their own HSA, and retaining what they did not spend in their tax advantaged account, they then become wiser consumers. HSA's are similar to Flexible Spending Accounts (FSA) and Health Reimbursement Accounts (HRA). HSA's are portable, earn tax deferred interest and can accumulate over time.

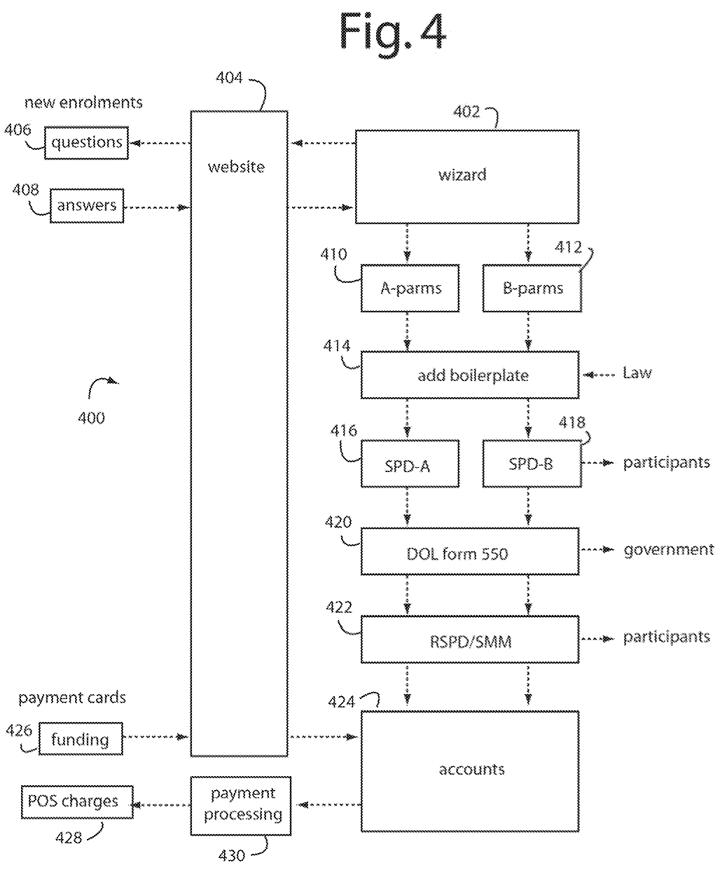

FIG. 4 is a block diagram of an FSA payment card benefits system embodiment of the present invention, referred to herein by the general reference numeral 400. System 400 includes a wizard 402 that is hosted at a website 404. New enrollments begin by asking the customer company a series of questions 406 which elicit answers 408. The wizard 402 will generate any number of variations on a basic ERISA plan, and these variations are represented here in two simple cases characterized by their essential A-parameters 410 and B-parameters 412. The parameters are distilled from the answers 408 and reflect the corresponding legal, policy, and technical consequences of the particular answers. Tables II and III are provided here to contrast, compare, and give some flavor for the external forces that dictate and constrain different ERISA and FSA programs, plans, and structures. Wizard 402 navigates through the path needed to suit the provided answers 408.

TABLE II
FSA/HRA/HSA Comparison

| Plan Design, | | | |
|---|---|---|---|
| Compliance Issues | Health FSA | HRA | HSA |
| Pre-tax salary funding | Permitted | Not permitted for HRA, | Permitted for both HSA and |
| | | but permitted for HDHP | HDHP Additionally, the HSA |
| | | offered with HRA | may also be funded with after |
| | | | tax dollars, as well |
| Carryover of unused amounts | Not permitted | Permitted but not required | Permitted Fully vested |
| | | | immediately |
| Medical expenses that are | IRS Code Section 213(d) | IRS Code Section 213(d) | IRS Code Section 213(d) |
| eligible for reimbursement | expenses incurred during | expenses incurred during | expenses incurred during |
| | the coverage period | the coverage period | the coverage period which |
| | No insurance premiums | Includes insurance | have not been reimbursed |
| | No long-term care | premium | No insurance premiums |
| | services | Includes long-term care | other than for COBRA or |
| | | insurance | qualified LTC premiums, |
| | | Cannot reimburse LTC | or insurance premiums |
| | | premiums if HRA is in a | while receiving |
| | | FSA | unemployment or is over |
| | | | the age of 65 |
| Cash out of unused amounts | Not permitted | Not permitted | Permitted, but results in |
| | | | taxable income |
| | | | Subject to 10% excise tax |
| | | | Excise tax waived for |
| | | | participants over age 65, |
| | | | following death or in a |
| | | | divorce situation |
| Medical expense incurred in | Applies | Does not apply | Does not apply if expense is |
| the plan year of the | | | incurred after the HSA is |
| contribution | | | created |
| Limitation on mid-year | Applies | Does not apply since HRS | Applies if funded through a |
| changes in the absence of life | | is funded solely with | cafeteria plan |
| status change | | employer funds | May apply if funded |
| | | | through pre-tax employee |
| | | | contributions |
| | | | Does not apply if funded |
| | | | by the employer of with |
| | | | employee after tax |
| | | | contributions |
| Annual amount required to be | Applies | Does not apply | Does not apply |
| available on the first day of | | | |
| coverage | | | |
| Ability to spend down | Can only be used for | Depends upon the | Depends upon terms of the |
| accumulated amounts after | claims incurred prior to | provisions of the Plan | Plan Document |
| cessation of active | termination unless COBRA | Document | Funds can be distributed |
| participation | is chosen | | after termination subject to |
| | | | income tax |
| | | | Excise tax applies to funds |
| | | | spent on non-qualified |
| | | | medical expenses |
| Third party claims | Required | Required | Not statutorily required, but |
| adjudication | | | guidance says that an HSA |
| | | | must be treated the same as |
| | | | an MSA, which does not |
| | | | require third party |
| | | | adjudication |
| Limitation on having other | None | None | Applies |
| health insurance | FSA must generally be | FSA must generally be | Participant not allowed to |
| coverage(stacking) | the payor of last resort | the payor of last resort | have an HSA if covered as |
| | However, Plan | However, Plan | a participant or dependent |
| | Document wording may | Document wording may | under any other health |
| | change the order of | change the order of | plan, including an HRA or |
| | benefit determination | benefit determination | medical FSA |
| | | | Stacking over HDHP |
| | | | allowed |
| Non-discrimination | Applies | Applies | Does not apply to HSA |
| requirements (Code 105(b)) | | | Employer contributions |
| | | | must be “comparable” |
| | | | Must be the same amount |
| | | | or percentage for all |
| | | | similarly situated |
| | | | employees |
| | | | Section 125 discrimination |
| | | | rules apply |
| Is a trust account required? | Possibly by ERISA, but | Possibly by ERISA, except | Required |
| | not by the IRS | if reimbursements are | |
| | | made out of the general | |
| | | assets of the employer, but | |
| | | not by the IRS | |
| Are account earnings taxable | Generally, no if | Generally, no if | Not if there is a qualified |
| to participant? | reimbursements are made | reimbursements are made | HSA Trust document |
| | directly out of the general | directly out of the general | Some cash out amounts |
| | assets of the employer for | assets of the employer for | may be taxed |
| | covered medical expenses | covered medical expenses | |
| | and are not set aside in a | and are not set aside in a | |
| | separate account | separate account | |
| ERISA applicability for | Applies | Applies | Does not apply if the “safe |
| ERISA covered employers | | | harbor” conditions are met: |
| | | | No contributions are |
| | | | made be the employer |
| | | | (pre-tax contributions are |
| | | | considered as employee |
| | | | contributions for DOL |
| | | | purposes) |
| | | | Participation is |
| | | | completely voluntary |
| ERISA applicability for | Applies | Applies | The employer does not |
| ERISA covered employers | | | endorse the program, but |
| | | | can publicize the program |
| | | | and facilitate pre-tax |
| | | | contributions |
| | | | The employer receives no |
| | | | consideration other than |
| | | | “reasonable” compensation |
| | | | for services actually |
| | | | rendered |
| Funding | Not required | Not required | Required to be in trust |
| Plan asset issues | Salary reduction amounts | Generally not plan asset if | Considered as a plan asset |
| | are considered as plan | funded out of the | once placed in a qualified |
| | assets | employers general assets, | trust |
| | | but may be an asset if | |
| | | segregated | |
| Reporting | Required for 100+ | Required for 100+ | Applies if there are employer |
| | | | contributions |
| ERISA summary plan | Required | Required | May apply if there are |
| description (SPD) | | | employer |

TABLE III

| | |
|---|---|
| employee eligibility | all employees are eligible, subject to employer- |
| | designed exclusions |
| ineligible persons | self-employed individuals, including more than-2% |
| | shareholders of a Subchapter S corporation and |
| | partners in a partnership are not eligible |
| funding | funding with cafeteria plan salary reductions is |
| | permitted |
| Can unused amounts be carried over | No, although a plan may be amended to allow a |
| to the next year? | grace period of up to 2 1/2 months during which |
| | claims may be incurred. |
| What medical expenses are eligible | Otherwise unreimbursed Code § 213(d) medical |
| for reimbursement? | expenses incurred during the coverage period. |
| | Cannot reimburse insurance premiums. Cannot |
| | reimburse qualified long-term care services. |
| distributions | distributions (or cash outs) for non-medical |
| | expenses are not permitted |
| term | coverage must be elected/provided for a full 12- |
| | month period. and are there prohibitions on midyear |
| | changes? |
| coverage | uniform coverage rules apply, requiring the annual |
| | coverage amount to be available as of the first day |
| | of the plan year |
| Can amounts that are unused at | Generally no. Cannot use unused amounts to pay for |
| termination of active employment | claims incurred after termination (except as COBRA |
| continue until spent down? | or a plan's grace-period might allow). |
| To be reimbursable, claims must be | |
| incurred during current period of | |
| coverage | |
| expense substantiation required | |
| claims adjudication is required. That | |
| is, must someone other than the | |
| covered employee/individual process | |
| and approve the claim | |
| | Generally, health FSAs must be payors of last |
| | resort. HRAs and health FSAs can be drafted to |
| | require that the HRA pays only after FSA amounts |
| | are exhausted. Cannot reimburse expenses that have |
| | been reimbursed elsewhere. |
| | Code § 105(h) nondiscrimination requirements may |
| | apply |
| Code § 125 nondiscrimination | Yes, for health FSA's offered under a cafeteria plan. |
| requirements apply? | |
| required trust account | not by the Code, but possibly by ERISA, no trust if |
| | health ESA complies with ERISA Tech. Rel. 92-01, |
| | including that reimbursements are made directly out |
| | of the general. assets of the employer |
| taxable account earnings | If reimbursements are made directly out of the |
| | general assets of the employer and account funds are |
| | not set aside in a separate account, there are no |
| | earnings to be taxed. If funds are deposited in a |
| | VEBA, earnings generally are not taxable. |
| | there is no requirement to set funds aside in a |
| | separate account, but an employer may do so |
| | any such funding may invoke ERISA's trust |
| | requirement if amounts are segregated from general |
| | assets |
| | Even for plans that are treated as “unfunded” under |
| | ERISA Tech. Rel 92-1, salary reduction amounts |
| | are plan assets for purposes of ERISA's exclusive |
| | benefit and fiduciary duty rules. |
| Is an ERISA Form 5500 required to | Yes, except for small unfunded plan with fewer than |
| be filed? | 100 participants |
| Do ERISA SPD and other | yes |
| disclosures and adherence to | |
| ERISA's benefit claims procedures | |
| apply? | |
| Do HIPPAA's portability, certificates | Yes. Exception for most (not all) health FSAs |
| of creditable coverage, and health | funded with salary reductions. |
| status nondiscrimination provisions | |
| apply? | |
| Do HIPPA's administrative | yes |
| simplification (including privacy) | |
| provisions apply? | |
| Does COBRA apply? | Yes. But there is a special rule limiting COBRA |
| | obligations for qualifying health FSAs. |

Standard clauses, or boilerplate document paragraphs 414 are added to characterizing clauses which incorporate the essential particulars coming from A-parameters 410 or B-parameters 412. A resulting business contract and summary plan description (SPD) meets the relevant legal requirements as they apply to the new enrollee company.

The system 400 will produce a summary plan description, SPD-A 416 or SPD-B 418, that is required to be provided to the plan participants. Under certain conditions that depend on answers 408, a summary annual report on Department of Labor Form DOL-550 will need to be created and sent to the Government. Any revisions to the SPD's require a revised SPD (RSPD) or summary of modifications (SMM) 422 to be sent to all participants.

At least an FSA account 424 will be created and funded by a process 426 that is given an Internet presence by website 404. When the payment cards are used at point-of-sale (POS) terminals, POS charges 428 are cleared by payment processing 430 and debits accounts 424 if compliant with the SPD-A 416 or SPD-B 418.

One embodiment of the present invention, to be commercialized under the WiredBenefits, Inc., trademark of Prepaid Healthcare Card Suite™, allows users to associate several cardholder-defined funding accounts and payment prioritizations, which are characterized by employer or sponsor predefined configurations. Cardholders have the opportunity to participate directly with promotional campaigns from service providers and product manufacturers to get more value in their purchasing.

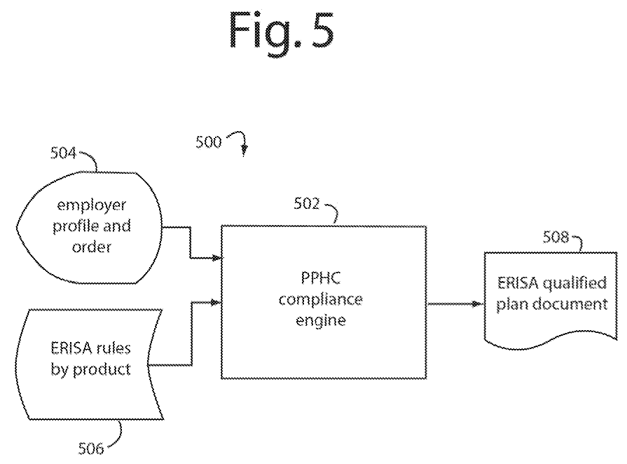

FIG. 5 represents a benefits ordering platform, and is referred to herein by the general reference numeral 500. The benefits ordering platform 500 is built around a prepaid healthcare card (PPHC) compliance engine 502. An essential function of any benefits ordering platform is to ensure compliance with ERISA regulations as they apply to particular programs and products. The PPHC compliance engine 502 uses compliance rules to derive an ERISA compliant Plan and the legal documentation as required by Law during the data collection and plan definition stages of ordering.

Connection to the benefit ordering platform 500 is through a public facing web interface, which is used to collect and process information from an employer. Each employer provides profile information 504 and responds to a sequence of questions and steps to define the product and the particulars of the order. The answers are processed by the PPHC compliance engine 502 and guided by ERISA rules for each product 506. The order results in a written document 508 that includes the information and constraints required by ERISA regulations.

In a multi-product ordering system, each product line can have its own unique set of constraining rules and parameters. Rules and parameters are typically built into libraries which are then accessed by platform 500. The libraries will direct the information collection flow. As information is collected during the ordering process, it is distilled into its key constituents or parameters and then saved in a relational database. This data store represents the plan 508, and can be reconstituted on demand.

Plan 508 construction is based on the parameters obtained during the ordering, much like the way DNA controls how living organisms grow. Plans are assembled from previously composed paragraphs that are threaded together to implement the parameters, and give effect to the legally required components for a given product. Plans 508 can be easily modified by changing the basic parameters used to define the Plan.

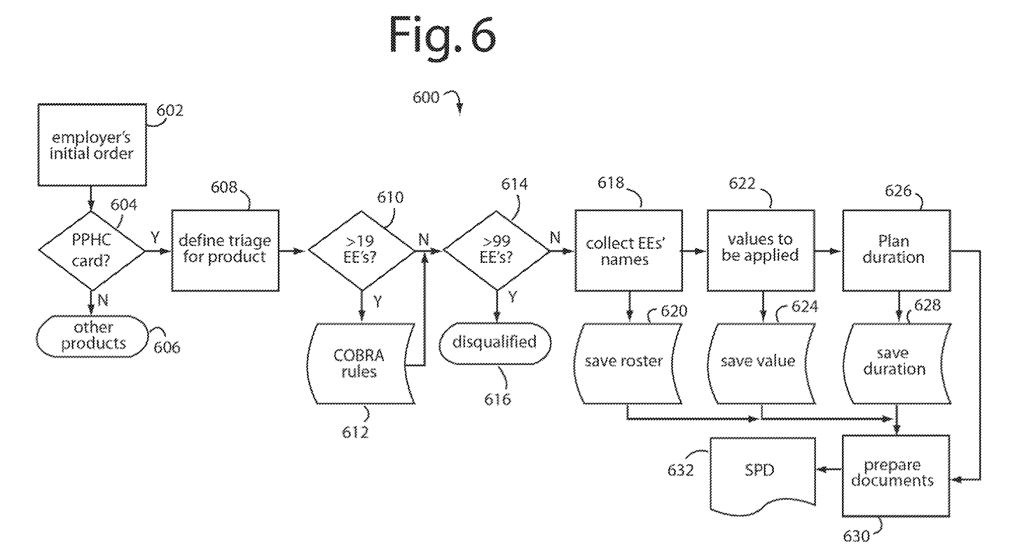

FIG. 6 is an illustration showing the preparation of a Plan for a prepaid healthcare tax-advantaged debit card product. The product is an employer-funded health benefit that is subject to ERISA rules and regulations. As such, the benefits provided will not be treated as taxable income to the enrolled employees.

In general, the ERISA requires that employers identically compensate every member of a class. Employers with more than twenty employees are subject to additional Consolidated Omnibus Budget Reconciliation Act (COBRA) considerations. Officers and large shareholders of the company must be excluded from the benefits. Each Plan has to be written based upon each unique combination of class of employees and benefit amount.

FIG. 6 represents a triage process flow and ordering method for a prepaid healthcare card product, and is referred to herein by the general reference numeral 600. The method 600 begins with a step 602 in which an employer places an initial order. a step 602 asks if this order is for a prepaid healthcare card. If not, a step 606 branches to another product process. But if the order is for a prepaid healthcare card, a step 608 runs a directed questioning and answering (triage) process. Answers to a sequence of questions provide the information and parameters needed to build an ERISA conforming Plan. The sequence of questions depends upon both the products being ordered and possible variations of parameter-driven plans.

Step 604 presents the first triage question, which determines the product and associate ERISA library to use. Step 606 builds a triage sequence and screen layout based on the ERISA Library associated with the product. Steps 610 determines if the plan requires a COBRA clause. Step 612 saves information into the plan parameters if COBRA applies. Step 614 determines if the number of employees exceeds the upper limit allowed for such plan, and step 616 disqualifies the order if so. Step 618 collects the names of the employees to be provided with prepaid healthcards under the plan, and step 620 saves the roster of employees. Step 622 collects the initial card values to be provided with the prepaid healthcards under the plan, and step 620 saves the funding preferences. Step 626 gets the plan duration be provided with prepaid healthcards, and step 628 saves the duration parameter. Step 630 immediately prepares the plan documents for publication, or later based upon the parameters stored in steps 620, 624, and 628. An SPD is produced in step 632, a typical example of which is recited in Table-IV.

TABLE IV
Sample SPD Document

YOUR EMPLOYER'S HEALTH REIMBURSEMENT ACCOUNT Plan Document/Summary Plan Description
Effective Date: OVERVIEW This document contains important information concerning the Employer Health
Reimbursement Account (the HRA or the “Plan”) and the PrepaidHealthcare MasterCard ® card. Specifically noted are the
following items: * eligibility rules * what constitutes an eligible expense, and * a summary of the laws that protect your
rights This document is not a contract between you and your employer. Your employer intends for the HRA to continue,
but reserves the right, in and at its sole discretion, to amend, modify in any manner or terminate the HRA at any time,
which may result in the modification or termination of your coverage. Your employer and the management staff at
PrepaidHealthcare have the final right to interpret any provision of the HRA.
Your employer will provide you with a PrepaidHealthcare MasterCard ® to use for all eligible medical expenses. You will
receive a separate document titled “Cardholder Agreement” with your card. The terms of the Cardholder Agreement are
incorporated herein.
The most current edition of this document is always available at www.prepaidhealthcare.com. Your employer maintains a
formal Plan document online for the HRA. In the event of a conflict between the Plan document and this document, the
formal Plan document will control; You should direct any questions you have to your employer. Access to your HRA
balance is always available at www.prepaidhealthcare.com. You will be required to input your 16-digit card number at sign
in.
**This document constitutes the Summary Plan Description of the HRA required by ERISA. * INTRODUCTION
Your employer has established an HRA for all eligible employees. This HRA is an arrangement that: * Consists of an
employer's crediting of amounts onto a personalized prepaid MasterCard ®. (Please note that any unused balance
remaining at the end of the Plan Year [January 1-December 31] will be carried forward as long as the Plan eligibility
rules are still met.) [Note: No separate account is established for HRA funds - rather, your accrued balance is funded by
your employer's general assets]
* Reimburses the covered employee for eligible medical expenses incurred by the employee or their tax dependents.
* Employees and their tax dependents may only receive reimbursement from the HRA for the period of time the employee
participant is employed by Employer in an eligible employment classification, subject to COBRA continuing coverage
explained below.
Amounts credited to your HRA by your employer are accessible through a personalized PrepaidHealthcare MasterCard ®,
and may not revert to cash under any circumstances. Also, your employer will only provide reimbursement for eligible
medical expenses, (as defined in Code Section 213(d)I incurred by you and your eligible tax dependents. Upon
employment termination (or loss of eligible status) all funds left in the HRA are forfeited unless you elect COBRA to
continue to access the remaining funds at the time of your termination by agreeing to pay the administrative fees paid by
your employer for active employees.
All fees will be automatically deducted from your HRA. If you choose COBRA continuation coverage, you are entitled to
the level of coverage under the HRA in effect for your immediately preceding the qualifying event. While COBRA is in
effect, you will be entitled to an increase in your HRA Balance equal to the sum of the HRA Dollars allocated to similarly
situated active participants (subject to any restrictions applicable to similarly situated active participants) so long as you
continue to pay the applicable HRA reloads. If you do not elect COBRA to continue to access the funds in your HRA, you
will then have 90 calendar days from the date of your employment termination to submit claims incurred during your time
as a covered participant. If after ninety calendar days following your termination, you have not elected to continue to
access funds in your HRA then all funds left in the HRA will be forfeited and the card will be deactivated.
The current employer's contribution schedule to the HRA can be viewed at www.prepaidhealthcare.com. Sign in to view
your Plan Document.
The employers' contributions to an employee's HRA are made available on the PrepaidHealthcare MasterCard ® on the
first day of each month, though this date can be adjusted by your employer.
ELIGIBILITY All active employees and their dependents are eligible as of the employee hire date or first date of this
Plan's adoption by your employer, whichever is more recent. Retirees are not eligible to participate in the HRA.
A dependent for purposes of this HRA is any individual who meets both of the following conditions: (i) the individual is a
legal “spouse” (as determined in accordance with state law to the extent consistent with federal law) or (ii) a “dependent”
as defined in Code Section 105(b).
In addition, this HRA may cover a child of yours (as defined by applicable state law) in accordance with a Qualified
Medical Child Support Order (“QMCSO”) to the extent the QMCSO does not require coverage not otherwise offered under
this HRA. The Plan Administrator (or its designee) will notify you if a medical child support order has been received. The
Plan Administrator will make a determination as to whether the order is a QMCSO in accordance with the Plan's QMCSO
procedures and will notify both you and the affected child once a determination has been made. You may request a copy of
the Plan's QMCSO procedures, free of charge, by contacting the Plan Administrator.
ELIGIBLE AND INELIGIBLE MEDICAL EXPENSES The IRS allows for the reimbursement of certain out-of-pocket
medical expenses by HRA accounts. In order to constitute an “eligible medical expense”, these expenses must be incurred
by you or your covered dependents for “medical care” as defined in Code Section 213(d) and must not have been
reimbursed by another plan. Additionally, an HRA may only reimburse a medical care expense that is incurred after the
date the HRA is in existence.
The following are eligible medical expenditures that your plan covers: * Retail Health Clinic visits * Prescriptions *
Qualifying over-the-counter (OTC) items To view a list of eligible medical expenses, visit www.prepaidhealthcare.com.
This listing is selected by your employer and PrepaidHealthcare and is based upon interpretation of the IRS rules and
regulations pertaining to HRA administration and is not intended to be legal advice. Whether an expense is an “eligible
medical expense” is within the sole discretion of the Plan Administrator.
Funds in the HRA are accessible to you by using the PrepaidHealthcare MasterCard ® (“MASTERCARD ®” or “the Card”)
when paying for eligible expenditures. This MASTERCARD ® is issued by BankFirst. The Card electronically accesses
and debits an employee's HRA when an eligible expenditure is incurred. If the funds are not in the account, the transaction
will simply be denied. The following is a summary of how reimbursement using the Card works: (a) You must agree to
abide by the terms and conditions of Card usage. In order to be eligible for the Card, you must agree to abide by the terms
and conditions of the Plan and in the Cardholder Agreement, including any fees applicable to Card usage, limitations as to
Card usage, the Plan's right to withhold and offset for ineligible claims, etc. You must agree to abide by the terms of the
Plan and Cardholder Agreement both during the initial card activation and during each annual election period. The Card
will be turned off effective the first day of each Plan Year if you do not affirmatively agree to abide by the terms of the
Plan during the preceding annual election period. The Cardholder Agreement is part of the terms and conditions of your
Plan and this SPD.
(b) You must certify proper use of the Card. As specified in the Cardholder Agreement, you certify during the applicable
election period that the amounts in your HRA will only be used for eligible medical expenses (i.e. medical care expenses
incurred by you, your spouse, and your tax dependents) and that you have not been reimbursed for the expense and that
you will not seek reimbursement for the expense from any other source. Failure to abide by this certification will result in
termination of Card use privileges.
(c) HRA reimbursement under the Card is limited to health care providers (including pharmacies). Use of the Card for
eligible medical expenses is limited to providers who have a health care related merchant category code and merchants
who utilize the Inventory Information Approval System described below. The Plan Administrator has sole discretion to
determine whether the provider has a health care related merchant category code.
NOTE: MANY PHARMACIES IN RETAIL AND DISCOUNT STORES WILL NOT QUALIFY AS MERCHANTS
WITH A HEALTH CARE RELATED MERCHANT CATEGORY CODE. The Plan Administrator will identify for you
the providers who utilize an Inventory Information Approval System.
(d) You swipe the Card at the health care merchant like you do any other debit card. When you incur an eligible medical
expense at a pharmacy or grocery store for a prescription drug or an over the counter drug expense, you swipe the Card
much like you would a typical credit or debit card.
The merchant is paid for the expense up to the maximum reimbursement amount available under the HRA (or as otherwise
limited by the Plan) at the time that you swipe the Card. Every time you swipe the Card, you certify to the Plan that the
expense for which payment under the HRA is being made is an eligible medical expense and that you have not been
reimbursed from any other source not will you seek reimbursement from another source.
(e) You must obtain and retain a receipt/third party statement each time you swipe the Card. You must obtain a third party
statement from the health care provider or an Explanation of Benefits form (e.g., receipt, invoice, etc.) that includes the
following information each time you swipe the Card: * The nature of the expense (e.g., what type of service of treatment
was provided).
* If the expense is for an over the counter drug, the written statement must indicate the name of the drug.
* The date the expense was incurred.
* The amount of the expense.
You must retain this receipt for three years following the close of the Plan Year in which the expense is incurred. Even
though payment is made under the Card arrangement, a written third party statement may be required to be submitted
(except as otherwise provided in the Cardholder Agreement). In instances regarding unrecognized expenses,
documentation may be requested of the cardholder to verify anthentication.
(f) There are situations where the third party statement may not be required to be provided to the Claims Administrator.
More detail as to which situations apply under your Plan is specified in the Cardholder Agreement. Generally, under the
Inventory Information Approval System (available at participating merchants with both a health care related merchant
category code and merchants who do not have a health care related merchant category code), the merchant retains a list of
eligible medical expenses sold by the merchant. The merchant only allows the Card to purchase items identified on that list
of eligible medical expenses retained by the merchant. For example, if you place both a prescription drug and a nonmedical
item on the counter and submit your Card, the merchant will only allow the Card to be used for the prescription drug
expense. You must pay for the expenses not on the merchant's eligible medical expense list with another form of payment
(cash, personal credit or debit card, etc).
You will not be permitted to use the Card at any merchant who does not have a health care related merchant category code
unless that merchant utilizes this Inventory Information Approval System.
Note: You should still obtain the third party receipt when you incur the expense and swipe the Card, even if you think it
will not be needed, so that you will have it in the event the Claims Administrator required it.
(h) You must pay back any improperly paid claims. If you are unable to provide adequate or timely substantiation as
required by the Claims Administrator, you must repay the Plan for the unsubstantiated expense. The deadline for repaying
the Plan is set forth in the Cardholder Agreement. If you do not repay the Plan within the applicable time period, the Card
will be turned off and an amount equal to the unsubstantiated expense will be offset against future eligible claims under the
HRA. If no claims are submitted prior to the date you terminate coverage in the Plan, or claims are submitted but they are
not sufficient to cover the unsubstantiated expense amount, then the amount may be withheld from your pay (as specified
in the Cardholder Agreement). Lastly, the employer may treat the unreimbursed amount as a bad business debt, which
could have income tax implications for you.
Traditional Paper Claims: If an expense is not recognized as an eligible medical expense when you use the Card, retain
your receipt and submit your claim using a traditional paper claim form, which can be downloaded from
www.prepaidhealthcare.com. File a claim with PrepaidHealthcare by completing and submitting a request for
reimbursement form. You must include with your request for reimbursement form a written statement from an independent
third party (e.g., a receipt, EOB, etc.) associated with each expense that indicates the following: * The nature of the
expense (e.g. what type of service or treatment was provided). If the expense is for an over the counter drug, the written
statement must indicate the name of the drug: * The date the expense was incurred; and * The amount of the expense.
Reimbursement for expenses that are determined to be eligible medical expenses will be made as soon as possible after
receiving the claim and processing it. If the expense is determined to not be an “eligible medical expense” you will receive
notification of this determination. You must submit all claims for reimbursement for eligible medical expenses 30 days of
incurring the expense.
IF YOU ARE DENIED A BENEFIT If you are denied a benefit under the Plan, you should proceed in accordance with
the following claims review procedures: Step 1: Notice is received from Third Party Administrator. If your claim is denied,
you will receive written notice from the Third Party Administrator that your claim is denied as soon as reasonably possible,
but no later than 30 days after receipt of the claim. For reasons beyond the control of the Third Party Administrator, the
Third Party Administrator may take up to an additional 15 days to review your claim. You will be provided written notice
of the need for additional time prior to the end of the 30-day period. If the reason for the additional time is that you need to
provide additional information, you will have 45 days from the notice of the extension to obtain that information. The time
period during which the Third Party Administrator must make a decision will be suspended until the earlier of the date that
you provide the information or the end of the 45-day period.
Step 2: Review your notice carefully. Once you have received your notice from the Third Party Administrator, review it
carefully. The notice will contain: * the reason(s) for the denial and the Plan provisions on which the denial is based; * if
the Claims Administrator relied on an internal rule, guideline, protocol, or similar criteria in making its determination,
either a copy of the specific rule, guideline, or protocol, or a statement that such a rule, guideline, protocol, or similar
criterion was relied upon in making the determination and that a copy will be provided upon request and free of charge,
* a description of any additional information necessary for you to perfect your claim, why the information is necessary, and
your time limit for submitting the information; * a description of the Plan's appeal procedures and the time limits
applicable to such procedures; and * a right to request all documentation relevant to your claim.
Step 3: If you disagree with the decision, file an Appeal. If you do not agree with decision of the Third Party
Administrator, you may file a written appeal.
You should file your appeal no later than 180 days after receipt of the notice described in Step 1. You should file your
appeal with the Third Party Administrator. You should submit all information identified in the notice of denial, as
necessary, to perfect your claim and any additional information that you believe would support your claim.
Step 4: Notice of Denial is received from Claims Reviewer. If the claim is again denied, you will be notified in writing. The
Third Party Administrator will send the notice no later than 30 days after receipt of the appeal.
Step 5: Review your notice carefully. You should take the same action that you took in Step 2 described above. The notice
will contain the same type of information that is provided in the first notice of denial provided by the Third Party
Administrator.
Step 6 (if there is a second level of appeal as indicated in the notice of denial): If you still disagree with the Third Party
Administrator's decision, file a 2nd Level Appeal with the Plan Administrator. If you still do not agree with the Third Party
Administrator's decision, you may file a written appeal with the Plan Administrator within 60 days after receiving the first
level appeal denial notice from the Third Party Administrator. You should gather any additional information that is
identified in the notice as necessary to perfect your claim and any other information that you believe would support your
claim.
Important Information Other important information regarding your appeals: * Each level of appeal will be independent
from the previous level (i.e., the same person(s) or subordinates of the same person(s) involved in a prior level of appeal
will not be involved in the appeal); * On each level of appeal, the claims reviewer will review relevant information that you
submit even if it is new information; and * You cannot file suit in federal court until you have exhausted these appeals
procedures.
COORDINATION OF BENEFITS This Plan is intended to pay benefits solely for otherwise unreimbursed eligible
medical expenses. To the extent the otherwise eligible medical expense is payable or reimbursable from another source,
the other source shall pay or reimburse prior to payment or reimbursement from this Plan to the extent permissible
under applicable law. Medicare is the exception to this rule, Medicare must always be secondary payor for active
employees and their dependents.
GENERAL INFORMATION ABOUT THE HRA * The name of the HRA (also referred to herein as “the Plan”) is
Employer Health Reimbursement Account.
* The Plan name is [INSERT PALN NAME] * The Plan Year begins on January 1 and ends on December 31.
* The provisions of this HRA become effective on the date at the top of this document.
* The federal tax identification number for your employer is: [INSERT EMPLOYER EIN] * Name and address of
Employer [INSERT EMPLOYER NAME] [INSERT EMPLOYER ADDRESS] * Name, address, and phone number of
Plan Administrator: Same as above.
* Address for service of legal process: Same as above.
* The employer keeps all records for the HRA and is responsible for the administration of the HRA.
* Your employer is the Plan Administrator of this HRA.
* All decisions made by the Plan Administrator are conclusive and binding.
* The employer is the HRA's Agent for service of legal process.
* Funding Policy: The HRA is not funded or insured, Benefits are paid from the general assets of the employer. Under no
circumstances will the benefits be funded with salary reduction contributions or contributions from Employees.
YOUR RIGHTS UNDER ERISA This HRA may be a welfare benefit plan as defined in the Employee Retirement
Income Security Act (ERISA). If it is an employee welfare benefit plan subject to ERISA, ERISA provides that you, as a
Plan participant, will be entitled to: 1. Receive Information about Your Plan and Benefits Examine, without charge, at
the Plan Administrator's office and at other specified locations, such as worksites and union halls, all documents governing
the Plan, including insurance contracts, collective bargaining agreements, and, if applicable, a copy of the latest annual
report (Form 5500 series) filed by the Plan with the U.S. Department of Labor and available at the Public Disclosure Room
of the Pension and Welfare Benefit Administration.
Obtain, upon written request to the plan administrator, copies of all documents governing the operation of the plan,
including insurance contracts and collective bargaining agreements, and copies of the latest annual report, if applicable,
(Form 5500 series) and updated Summary Plan Description. The Plan Administrator may apply a reasonable charge for the
copies.
2. Continue Component Medical Plan Coverage Continue health coverage for you, your spouse, or your dependents if
there is a loss of coverage under the Plan as a result of a qualifying event. However, you or your dependents may have to
pay for such coverage. Review this Summary Plan Description and the documents governing the Plan on the rules
governing your COBRA continuation coverage rights.
Obtain reduction or elimination of exclusionary periods of coverage for preexisting conditions under your Component
Medical Plan, if you have creditable coverage under another plan. You should be provided a certificate of creditable
coverage, free of charge, from your Component Medical Plan or health insurance issuer when you lose coverage under the
Plan, when you become entitled to eleci COBRA continuation coverage, when your COBRA continuation coverage ceases
(if you requested continuation coverage), before losing coverage (if you requested continuation coverage), or up to 24
months after losing coverage (if you requested continuation coverage). Without evidence of creditable coverage, you may
be subject to a preexisting condition exclusion for 12 months (18 months for late enrollees) after your enrollment date in
your coverage.
3. Prudent Actions by Plan Fiduciaries In addition to creating rights for Plan participants, ERISA imposes duties upon
the people who are responsible for the operation of the Employee Benefit Plan. The people who operate your Plan, called
“fiduciaries” of the Plan, have a duty to do so prudently and in the interest of the Plan participants and beneficiaries. No
one, including your employer, your union, or any other person, may fire you or otherwise discriminate against you in any
way to prevent you from obtaining a welfare benefit from the Plan, or from exercising your rights under ERISA.
4. Enforcement of Your Rights If your claim for a welfare benefit under an ERISA-covered plan is denied in whole or in
part, you must receive a written explanation of the reason for the denial. You have the right to have the Plan review and
reconsider your claim. Under ERISA, there are steps you can take to enforce the above rights. For instance, if you request
materials from the Plan and do not receive them within 30 days, you may file suit in a federal court. In such a case, the
court may require the Plan Administrator to provide the materials and pay you up to $110 a day until you receive the
materials, unless the materials were not sent because of reasons beyond the control of the Administrator. If you have a
claim for benefits that is denied or ignored in whole or in part, you may file suit in a state or federal court. In addition, if
you disagree with the plan's decision or lack thereof concerning the qualified status of a domestic relations order or a
medical child support order, you may file suit in federal court. If it should happen that plan fiduciaries misuse the Plan's
money or if you are discriminated against for asserting your rights, you may seek assistance from the U.S. Department of
Labor, or you may file suit in a federal court. The court will decide who should pay court costs and legal fees. If you are
successful, the court may order the person you have sued to pay these costs and fees. If you lose, the court may order you
to pay these costs and fees (e.g., if it finds your claim is frivolous).
5. Assistance with Your Questions If you have any questions about the Plan, you should contact the Plan Administrator.
If you have any questions about this statement or about your rights under ERISA, or if you need assistance obtaining
documents from the Plan Administrator, you should contact the nearest office of the U.S. Department of Labor, Employee
Benefits Security Administration, listed in your telephone directory, or the Division of Technical Assistance and Inquiries,
Employee Benefits Security Administration, U.S. Department of Labor, 200 Constitution Ave., N.W., Washington, D.C.,
20210. You may also obtain certain publications about your rights and responsibilities under ERISA by calling the
publications hotline of the Employee Benefits Security Administration. See http://www.dol.gov for more information.
PRIVACY We understand that medical information about you and your health is personal. We are committed to
protecting medical information about you. We create a record of the health care claims reimbursed under the Plan for Plan
administration purposes. We are required by law to: 1. Make sure that medical information that identifies you is kept
private; 2. Give you this Notice of our legal duties and privacy practices with respect to medical information about you;
and 3. Follow the terms of the notice that is currently in effect.
How We May Use and Disclose Medical Information About you The following categories list the different ways that
we use and disclose medical information; for treatment (as described in applicable regulations), for payment (as described
in applicable regulations) and for health care operations (as described in applicable regulations).
In addition, as required by law, we will disclose medical information about you when required to do so by Federal, State or
local law or to avert a serious threat to health or safety.
Other uses and disclosures of medical information not listed in this Notice or the laws that apply to us will be made only
with your written permission.
To view and download a copy of the complete Privacy Statement please visit www.prepaidhealthcare.com.
NOTICES OF OTHER FEDERAL LAW Newborns' and Mothers' Health Protection Act of 1996. Group health
plans and health insurance issuers generally may not, under federal law, restrict benefits for any hospital length of stay in
connection with childbirth for the mother or newborn child to less than 48 hours following a vaginal delivery, or less than
96 hours following a cesarean section. However, federal law generally does not prohibit the mother's or newborn's
attending provider, after consulting with the mother, from discharging the mother or her newborn earlier than 48 hours (or
96 hours, as applicable). In any case, plans and issuers may not, under federal law, require that a provider obtain
authorization from the plan or the issuer for prescribing a length of stay not in excess of 48 hours (or 96 hours).
Women's Health and Cancer Rights Act of 1998 (WHCRA). If you have had or are going to have a mastectomy, you
may be entitled to certain benefits under the Women's Health and Cancer Rights Act of 1998 (WHCRA). For individuals
receiving mastectomy-related benefits, coverage will be provided in a manner determined in consultation with the
attending physician and the patient, for: * All stages of reconstruction of the breast on which the mastectomy was
performed; * Surgery and reconstruction of the other breast to produce a symmetrical appearance; * Prostheses; and *
Treatment of physical complications of the mastectomy, including lymphedemas.
These benefits will be provided subject to the same deductibles, if any, and coinsurance, if any, applicable to other medical
and surgical benefits provided under this Plan.
If you would like more information of WHCRA benefits, call your Plan Administrator.

While a system for an employer to provide health benefit debit cards for employees is described here in particular, such system could also be general purpose and implemented for a sponsor with cardholder beneficiaries with flexible spending accounts that are limited to authorized types of purchases.

Although the present invention has been described in terms of the presently preferred embodiments, it is to be understood that the disclosure is not to be interpreted as limiting. Various alterations and modifications will no doubt become apparent to those skilled in the art after having read the above disclosure. Accordingly, it is intended that the appended claims be interpreted as covering all alterations and modifications as fall within the “true” spirit and scope of the invention.

What is claimed is:

1. A benefits plan ordering system, comprising:
an Internet website for access by new benefits plan customers;
an ordering process for presenting a minimum number of selected questions related to a benefits plan to said new benefits plan customers through the Internet website, and for receiving their answers in response;
a device to output a series of questions in the ordering process that are necessary to be able to characterize a particular ERISA-compliant benefits plan by an employer for their employees;
a device to interpret a series of answers provided by said employer; and
a publishing device for resulting business contract and summary plan description (SPD) that meets the relevant legal requirements as they apply to each new enrollee company.

2. The benefits plan ordering system of claim 1, further comprising:
a process for said new benefits plan customers to fund payment cards used by said employees.

3. The benefits plan ordering system of claim 1, further comprising:
a process for generating Department of Labor form 550 reports.

4. The benefits plan ordering system of claim 1, further comprising:
a process for archiving each particular ERISA-compliant benefits plan and for modifying them using simply their essential characteristic parameters.

5. A benefits ordering system for providing flexible spending account debit cards to employees and that enrolls their employer in a Plan that ensures compliance with ERISA regulations;
wherein, such system applies compliance rules during a data collection and plan definition stages of ordering, and produces an ERISA-compliant Plan and documentation as legally required.

6. The benefits ordering system of claim 5, further comprising:
a directed questioning and answering wizard to guide companies and participants through the placing of orders for custom fit ERISA-compliant benefits plan products on an Internet website.

7. The benefits ordering system of claim 6, wherein each particular sequence of questions depends on the particular products being ordered, and produces a set of characteristic parameters that fully describe possible variations in the plans.

8. The benefits ordering system of claim 5, further comprising:
a set of rules and parameters built into libraries used by the system, and that combine to direct information collection flows.

9. The benefits ordering system of claim 8, wherein, each type of Plan is constructed from previously composed paragraphs that are threaded together to encapsulate the set of rules and parameters and to include required components.

10. The benefits ordering system of claim 7, wherein, each Plans can be modified, and new compliance rules can be met, by a simple change to the set of rules and parameters.
